(19) United States
(12) Patent Application Publication
(10) Pub. No.: US 2013/0154132 A1
(43) Pub. Date: Jun. 20, 2013

(54) LIFTABLE AERATION ASSEMBLY AND METHODS OF PLACING AN AERATION ASSEMBLY INTO A RECEPTACLE

(71) Applicant: Parkson Corporation, Fort Lauderdale, FL (US)

(72) Inventors: Russell L. COOK, Margate, FL (US); Vipin Lillaney, Pompano Beach, FL (US); Michael Herbert Jakob, Fairfax, VA (US)

(73) Assignee: Parkson Corporation, Fort Lauderdale, FL (US)

(21) Appl. No.: 13/693,926

(22) Filed: Dec. 4, 2012

Related U.S. Application Data
(60) Provisional application No. 61/567,041, filed on Dec. 5, 2011.

(51) Int. Cl. B01F 3/04

(52) U.S. Cl. CPC B01F 3/04241
USPC 261/53; 261/124; 414/800

(57) ABSTRACT

The disclosed apparatus aeration assembly is used for submersion in and aeration of wastewater contained in a receptacle. The assembly may comprise a non-floating planar grid supporting a plurality of gas diffuser panels. The supporting grid may have at least two ends; one or more gas inlets affixed to one of the at least two ends for supplying gas to the plurality of gas diffuser panels; and one or more lift lines of a predetermined length affixed to each of the at least two ends with all lift lines meeting at a juncture. The juncture may be positioned above a plane of the supporting grid so that the predetermined length of a line affixed to one of the at least two ends is unequal to the predetermined length of a line affixed to another of the at least two ends.

### CROSS-REFERENCE TO RELATED PATENT APPLICATIONS

This application claims priority from U.S. Provisional Application No. 61/567,041, filed Dec. 5, 2011, incorporated herein by reference in its entirety.

### BACKGROUND

The invention generally relates to aeration assemblies for introducing bubbles of gas, such as air, into a liquid body, including a tank of water, water basin, reservoir, or lake.

Conventional aeration panel structures having an upper portion consisting of a membrane mounted on a lower portion consisting of a flat, rigid plate are known, for example U.S. Pat. No. 5,192,467. Such structures have peripheral hold-down strips, which secure the membrane to the rigid plate. Middle hold-down strips are sometimes provided to prevent billowing of the membrane. Adjustable anchor bolts hold the aeration panel structure to the bottom of a liquid container. Such panels are heavy, unwieldy when large, and difficult to transport and install. For this rigid plate approach, different materials, such as stainless steel or non-flexible plastic plates, are joined to flexible upper membrane sheets using screws, clamps or adhesives. Examples of other conventional aeration panel structures are also discussed in U.S. Pat. No. 5,192,467. Other aeration panel structures are also known, such as aeration panels described in German Patent Publication No. 29 42 697 and EP Patent Publication No. 0 229 386. Another example is U.S. Pat. No. 4,624,781, which describes a panel-type air diffusion device having an upper flexible membrane that is clamped to a lower rigid support plate. A further example is U.S. Pat. No. 5,015,421, which discloses a flexible membrane clamped to a rigid support with continuous clamping arrangements rather than point attachments, such as screws or rivets.

Still other aeration panels are known. For example, U.S. Pat. No. 6,406,005 discloses a rigid base plate and a perforated elastomeric membrane secured to the rigid base plate by sealing strips pressed along the edges of the membrane into corresponding grooves in the rigid base plate. Additionally, U.S. Pat. No. 5,532,391 describes a gas distributor including a base plate over which a perforated diaphragm is stretched and in which excessive expansion of the diaphragm is prevented by an upper grating. Furthermore, EP Publication No. 0 761 294 discloses an aerator panel with a perforated membrane secured to a support plate at the periphery and at central points on the panel while EP Publication No. 0 747 031 describes an anatomically shaped air bubble mat for use in a bathtub.

Fine bubble aeration for wastewater treatment has gained wide acceptance in both the municipal and industrial sectors as electric costs, thus treatment costs, have risen. The “green” movement has added emphasis to utilizing high efficiency technologies over previous less efficient process. Also, high efficiency systems offer the opportunity to increase plant capacity without the need for costly infrastructure construction. Current designs are all rigidly mounted at precise positions within the aeration basin structure. Installation requires that the basins be removed from service and drained and cleaned before conversion can be made. Many existing plants complete treatment in a single basin. As a result, the possibility of installing efficient, green technologies is precluded since there is no opportunity to take the basin out of service. Also, conventional systems typically require access to the aeration system which again requires that the basins be removed from service, drained, etc.

### SUMMARY

According to one embodiment of the present invention, an aeration assembly for submersion in and aeration of wastewater contained in a receptacle may comprise a non-floating planar grid supporting a plurality of gas diffuser panels. The supporting grid may have at least two ends and may include: (a) one or more gas inlets affixed to one of the at least two ends for supplying gas to said plurality of gas diffuser panels; and (b) one or more lift lines of a predetermined length affixed to each of the at least two ends with all lift lines meeting at a juncture. The juncture may be positioned above a plane of said supporting grid so that the predetermined length of a line affixed to one of the at least two ends is unequal to the predetermined length of a line affixed to another of the at least two ends.

According to another embodiment of the present invention, a method of lifting an aeration assembly positioned on a floor of a receptacle, the aeration assembly comprising a non-floating planar grid supporting a plurality of gas diffuser panels, said supporting grid having at least two ends, each end affixed to one or more lift lines of a predetermined length with all lift lines meeting at a juncture, may comprise: (a) providing a connection to the juncture such that the predetermined length of a lift line affixed to one of the at least two ends is unequal to the predetermined length of a line affixed to another of the at least two ends when the juncture is positioned above a plane of said supporting grid; and (b) applying a force to the juncture, using the connection, sufficient to lift the aeration assembly from its position on the floor of the receptacle.

According to another embodiment of the present invention, a method of lowering an aeration assembly into a receptacle, the aeration assembly comprising a non-floating planar grid supporting a plurality of gas diffuser panels, said supporting grid having at least two ends, each end affixed to one or more lift lines of a predetermined length with all lift lines meeting at a juncture, may comprise: (a) suspending the aeration assembly above the receptacle by applying a force to the juncture, which is sufficient to overcome gravity, such that the predetermined length of a lift line affixed to one of the at least two ends is unequal to the predetermined length of a line affixed to another of the at least two ends as the juncture is positioned above a plane of said supporting grid; and (b) lowering the suspended aeration assembly, while continuing to apply the force to the juncture, into the receptacle.

It is to be understood that both the foregoing general description and the following detailed descriptions are exemplary and explanatory only, and are not restrictive of the invention as claimed.

### BRIEF DESCRIPTION OF THE DRAWINGS

The features, aspects, and advantages of the present invention will become apparent from the description, appended claims, and the accompanying exemplary embodiments shown in the drawings, which are briefly described below.

FIG. 1 shows an aeration assembly according to one embodiment of the present invention.

FIG. 2 shows a perspective view of a plurality of assemblies of FIG. 1 submersed in a receptacle according to one embodiment of the present invention.

FIG. 3 shows a side view of a plurality of aeration assemblies in a receptacle according to another embodiment of the present invention.

FIG. 4 shows an gas diffuser panel according to one embodiment of the present invention.

FIG. 5 shows a bottom view of a non-floating supporting grid according to one embodiment of the present invention.

FIG. 6 shows a bottom view of a non-floating supporting grid according to another embodiment of the present invention.

FIG. 7 shows a view of the end of a lift line that is connected to the supporting grid according to one embodiment of the present invention.

FIG. 8 shows the lift lines connected to an aeration assembly according to one embodiment of the present invention.

FIGS. 9A-9F show the method of installing the aeration assemblies into the receptacle according to one embodiment of the present invention.

FIGS. 10A-10E show the method of lifting or removing the aeration assemblies from the receptacle according to one embodiment of the present invention.

FIG. 11 shows an aeration assembly with circular gas diffusers panels according to an embodiment of the present invention.

FIGS. 12A and 12B show a plurality of square gas diffuser panels and an aeration assembly, respectively, according to another embodiment of the present invention.

FIGS. 13A and 13B show a plurality of triangular gas diffuser panels and an aeration assembly, respectively, according to another embodiment of the present invention.

FIG. 14 schematically shows an aeration assembly according to one embodiment of the present invention with valves for controlling gas flow to different portions of the aeration assembly.

FIG. 15 shows an aerial view of a plurality of assemblies submersed in a receptacle according to another embodiment of the present invention.

FIG. 16 shows a cross sectional view taken along line XVI-XVI of FIG. 15.

FIG. 17 shows a detailed view A of the air inlet from the embodiment of FIG. 16.

FIG. 18 shows a detailed view B of the connection of the lift lines to the supporting grid from the embodiment of FIG. 16.

FIG. 19 shows a detailed view C of a holding bracket for an aeration panel from the embodiment of FIG. 16.

FIG. 20 shows a detailed view D of the pressure gauge connection from the embodiment of FIG. 16.

FIGS. 21-24 show detailed views of the planar grid from the embodiment of FIG. 16.

FIG. 25 shows the planar grid of FIG. 21 with gas flow tubes.

FIG. 26 shows a perspective view of the aeration assembly from the embodiment of FIG. 16.

### DETAILED DESCRIPTION

An aeration panel assembly and method of placing such an aeration assembly is provided. The aeration assembly may include a self supporting, non-floating supporting grid on which one or more gas diffuser panels are mounted. All required piping, valves, etc. to make the assembly operation are also included. The aeration assembly may include supports, lifting device, and placement guides such that they may be installed into existing receptacles, such as basins, without shutting the receptacles down. Also, if maintenance is required, each aeration assembly may be individually removed from the receptacle without shutting down and without affecting the rest of the treatment process. Thus, the conversion of any aeration process to high efficiency, energy saving technology may be utilized.

Various embodiments of the present invention will be explained with reference to the accompanying drawings.

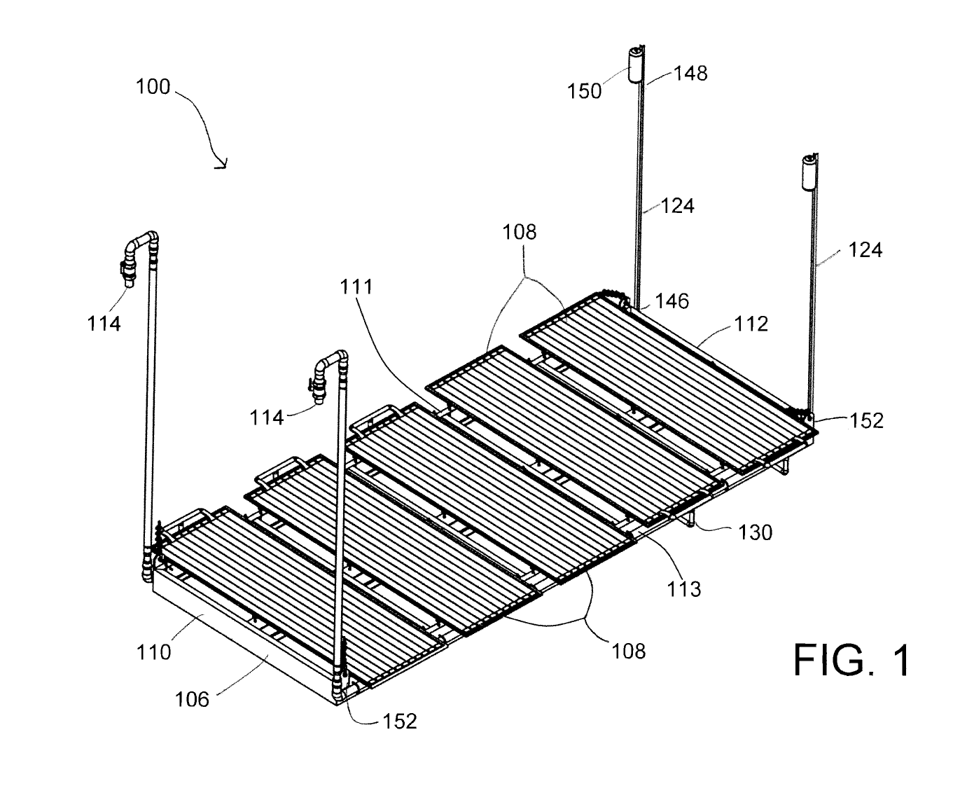

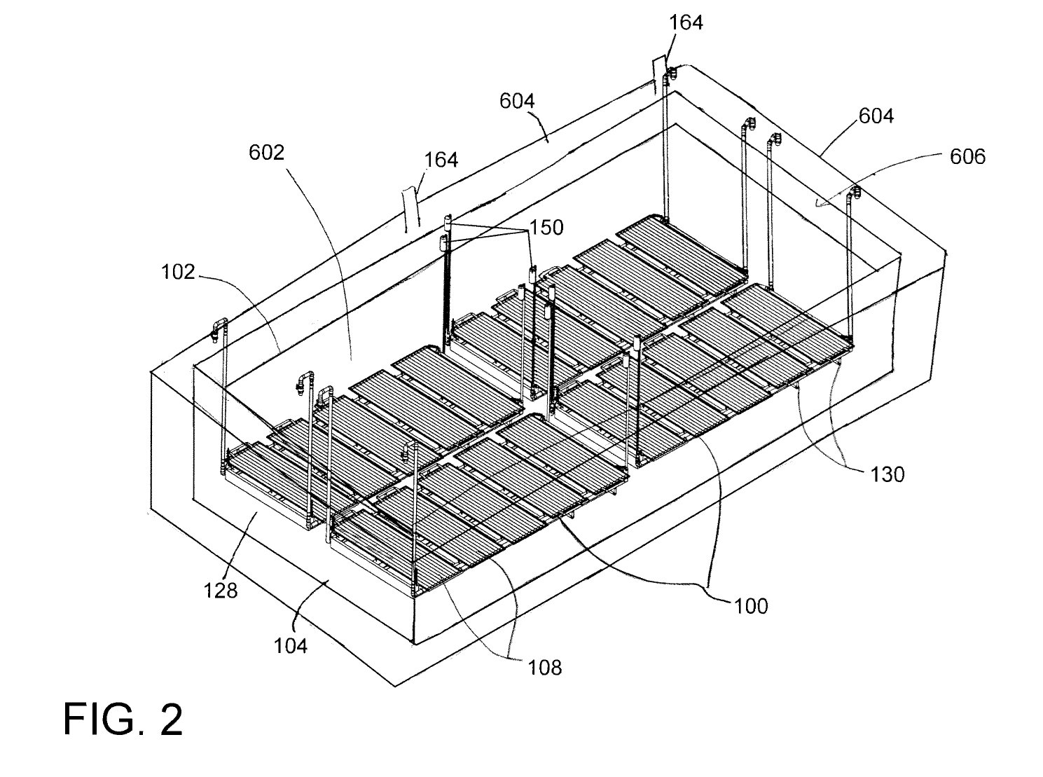

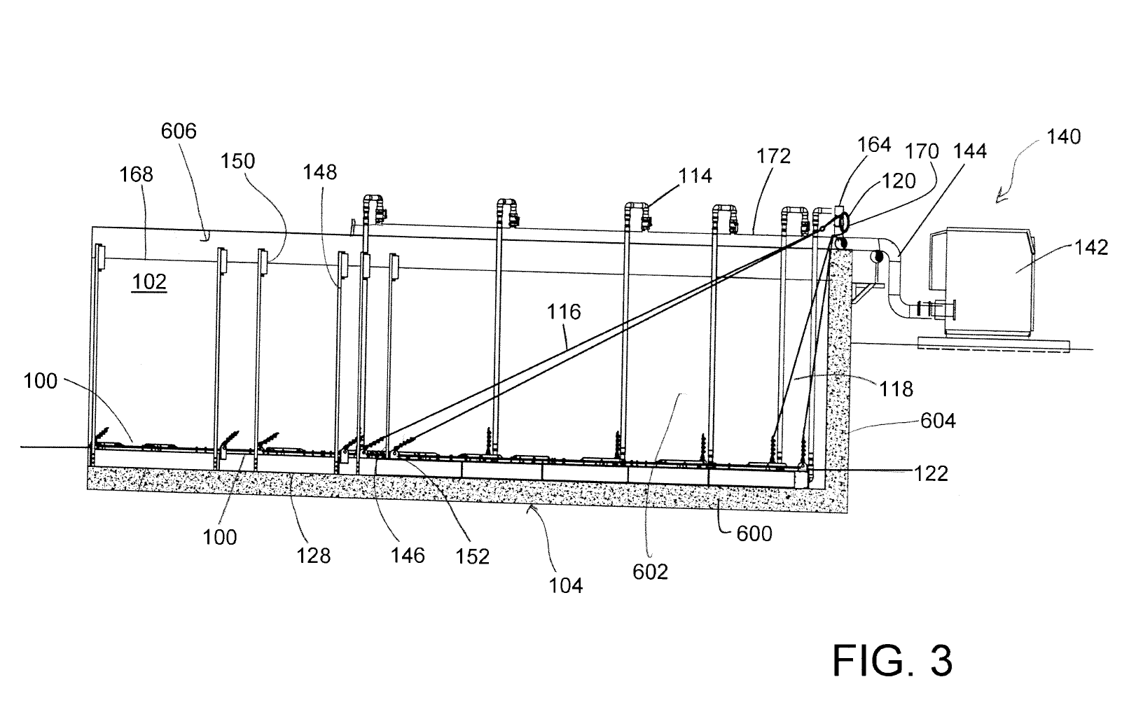

FIG. 1 shows an aeration assembly 100 for submersion in and aeration of wastewater contained in a receptacle. FIG. 2 shows a plurality of aeration assemblies 100 submersed in the wastewater 102 in a receptacle 104 according to one embodiment of the present invention while FIG. 3 shows a plurality of aeration assemblies 100 submersed in the wastewater 102 in a receptacle 104 according to another embodiment of the present invention.

The receptacle 104 may be a concrete basin, a metal tank, a vessel, reservoir, lake, or other structure used to contain liquid. For example, the receptacle 104 may have a floor or bottom wall 600 and one or more side walls 604 protruding vertically from the floor 600 so as to form a space 602 bounded by the floor 600 and the side walls 604. An opening 606 is formed by the periphery of the side walls 604 at the upper end of the receptacle 104 so that access to the space 602 can be obtained.

The wastewater 102 may be any suitable liquid or mixture in which water is a significant component. For example, 5, 10, 20, 40, 80, 100% or any integer therebetween of the mixture may be water.

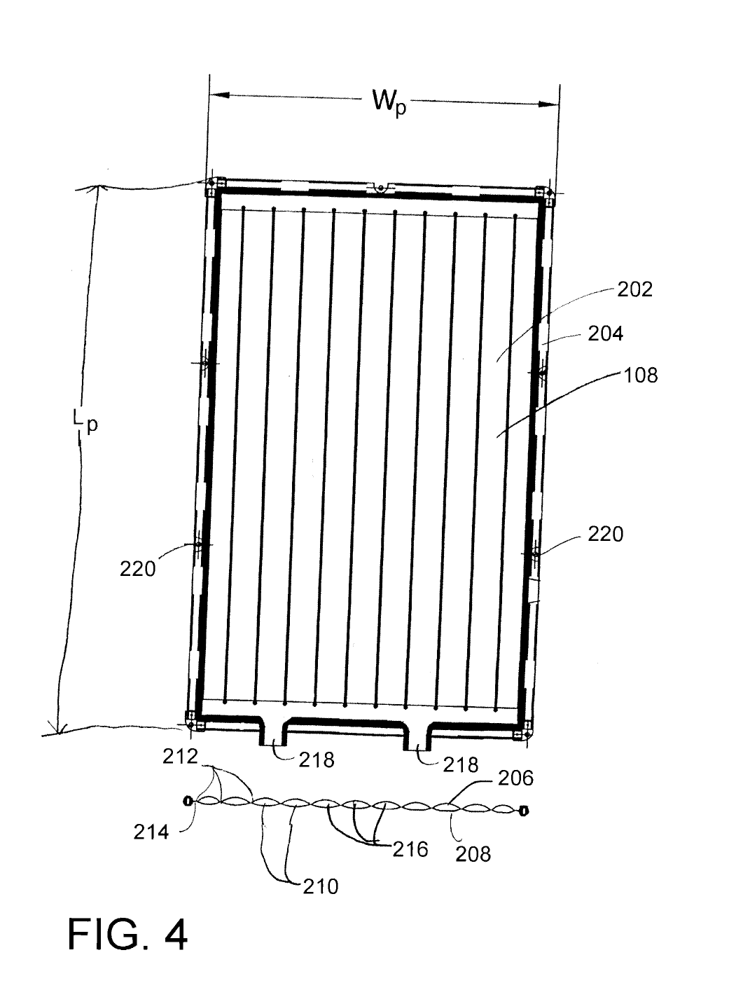

Each aeration assembly 100 may comprise a non-floating supporting planar grid 106 supporting a plurality of gas diffuser panels 108. FIG. 4 shows one suitable gas diffuser panel according to one embodiment of the present invention. In FIG. 4, the gas diffuser panel 108 has a rectangular aeration portion 202 and a frame 204. The aeration portion 202 may comprise an upper portion or sheet 206 and a lower portion or sheet 208. The upper portion 206 can comprise a flexible, elastomeric material harboring holes, slits, cut shapes, or otherwise perforated. The lower portion 208 can also comprise a flexible elastomeric material, which may be the same as or different from the flexible elastomeric material of the upper portion 206.

As to the perforations in the upper portion, the perforations can be configured in such a manner that a substantially uniform, unbroken pattern of gas bubbles can be provided over a substantial area of the upper portion 206 when gas flows through the aeration portion 202. Also, the perforations can come in a variety of sizes and shapes including, but not limited to, holes, slits, cuts, or combinations thereof. The dimensions of the perforations can come in many sizes but are preferably in the range of about 0.1 mm to about 10 mm, more preferably in the range of about 0.2 mm to about 5 mm and most preferably in the range of about 0.5 mm to about 3.0 mm. The perforations can be arranged in many different ways, including randomly or in symmetrical geometric forms, such as triangles, stars, rectangles, or in arrays. The density of the perforations can also vary widely and is determined by a ratio of open (perforated) to solid (non-perforated) areas. Such a ratio can range from about 5% to about 95% open area, preferably from about 15% to about 75% open area, and more preferably from about 30% to about 50% open area.

The material for the perforated upper portion 206 and non-perforated lower portion 208 can be constructed from a variety of flexible, non-rigid elastomeric materials. For example, these materials include, but are not limited to, polyurethanes, polyvinyl chloride, polycarbonates, acetals and polyacetals, nylons, polyethylene, polypropylene, chlorinated polyvinyl chloride, acrylic, vinyl acetate, and other plastics and the like, which can be made into flexible, gas impermeable sheets. Indeed, any flexible, non-rigid elastomeric material having a density of less than about 1.0 gm/mL can be used. In addition, natural and synthetic woven fabrics may also be used. Further examples of suitable materials for the upper and lower portions are described, for instance, in U.S. Pat. Nos. 6,846,534; 6,797,215; and 6,764,629, the disclosures of which are incorporated by reference herein. In a preferred embodiment, the upper and lower portions of the panels are made of the same (or different type of) flexible, non-rigid elastomeric material. In another embodiment of the present invention, the lower portion 208 can be formed by at least one layer of fabric imbibed or otherwise attached within two or more layers of elastomeric materials, such as polyurethane or polyester. In such a case, the fabric can be nylon, polyester, rayon, Kevlar, etc. In another embodiment, the lower portion 208 can comprise one layer of fabric between two layers of elastomeric material but other arrangements are possible. For example, two layers of fabric and three layers of elastomeric material can form a structure in which the layers of elastomeric material and the layers of fabric are alternately disposed.

The aeration portion 202 can be formed by sealing the upper portion 206 to the lower portion 208 thus defining one or more cavities 210 using one or more seals 212. The seals 212 can include one or more of the following: a weld, chemical bonding, vulcanization, stitching, an adhesive, and the like. In one embodiment, the flexible aeration panel may be formed by seals between the upper portion 206 and the lower portion 208 at the edges or periphery 214 of one or both of the upper and lower portions.

Additional seals 212 can extend across central regions (or interior sections) 216 near to the edges about the periphery 214, which create a plurality cavities 210 along longitudinal, transverse, or conical lines within the aeration portion 202, for example, in the manner of a ribbed flotation device. The seals 212 in the central regions are formed by attaching the upper portion 206 and the lower portion 208 along selected lines using an adhesive, melting methods, sewing, or other physical attachment methods. Such multiple cavity arrangements provide some rigidity to the overall structure of the aeration portion 202. Also, multiple cavity arrangements, together with the perforations on the upper portion 206 provide a plurality of large, relatively unobstructed passages for the flow of gases at high rates to all regions of the aeration portion 202, providing efficient aeration to the liquid body using an even distribution pattern of gas bubbles. In one embodiment, two or more cavities are formed, which follow the shape of the perimeter of the panel.

Additionally, the aeration portion 202 also includes at least one gas inlet 218 so gas can be delivered to the flexible aeration portion 202 using a feed tube 130 of the supporting grid 106 (such as shown in FIGS. 1, 2, and 5). The number of gas inlets 218 per gas diffuser panel 108 may be any suitable number, such as at least one, two, three, four, or more. FIG. 4, for example, shows an embodiment of a gas diffuser panel 108 with two gas inlets 218 while FIGS. 1, 2, 5, and 6, show gas panels with a single gas inlet. The inlet 218 may be positioned about the perimeter of the flexible aeration portion 202, or at an interior portion of the flexible aeration portion 202 near the central region(s) 216. The gas from a gas source is delivered under pressure to the cavities 210 via the feed tube 130 of the supporting grid 106 and the gas inlet 218. As gas fills the one or more cavities 210, the aeration portion 202 expands, and gas is permitted to exit through the perforations in the upper portion 206. Additionally, there can be an optional gas outlet provided in a region that enhances the even distribution of gas throughout the panel or provided so as to connect two or more aeration units mounted on the supporting grid 106 in series.

As shown in FIG. 4, the gas diffuser panel 108 may optionally include a structural frame 204, which can be disassembled and can preferably be used to mount the gas diffuser panel 108 to the supporting grid 106. In one preferred embodiment, the structural frame 204 can be attached along the edges of the aeration portion 202 along its periphery 214. In this way, the perforated upper portion 206 may be securely sealed to the supporting lower portion 208 around its periphery 214. The structural frame 204 of FIG. 4 generally circumscribes the periphery 214 of the aeration portion 202. The structural frame 204 can be made from a variety of suitable materials, such as metal or plastic such as PVC. In addition, the frame can have any suitable configuration. For example, the structural frame 204 of the embodiment shown in FIG. 4 can have a width Wp of about 0.1 to about 3 meters and have a length Lp of about 1 to about 5 meters long. Furthermore, the structural frame 204 can have a series of attachment points 220, such as apertures, along each side of the frame 204 through which attachment devices, such as bolts, anchor rods, or cables, are used to secure the aeration portion 202 to the structural frame 204 and/or to secure the structural frame 204 to the supporting grid 106.

According to an alternate embodiment, the structural frame 204 can be omitted and the aeration portion 202 can have a series of attachment points, such as apertures, along each side of the aeration portion 202 through which attachment devices, such as bolts, anchor rods, or cables, are used to secure the aeration portion 202 directly to the supporting grid 106.

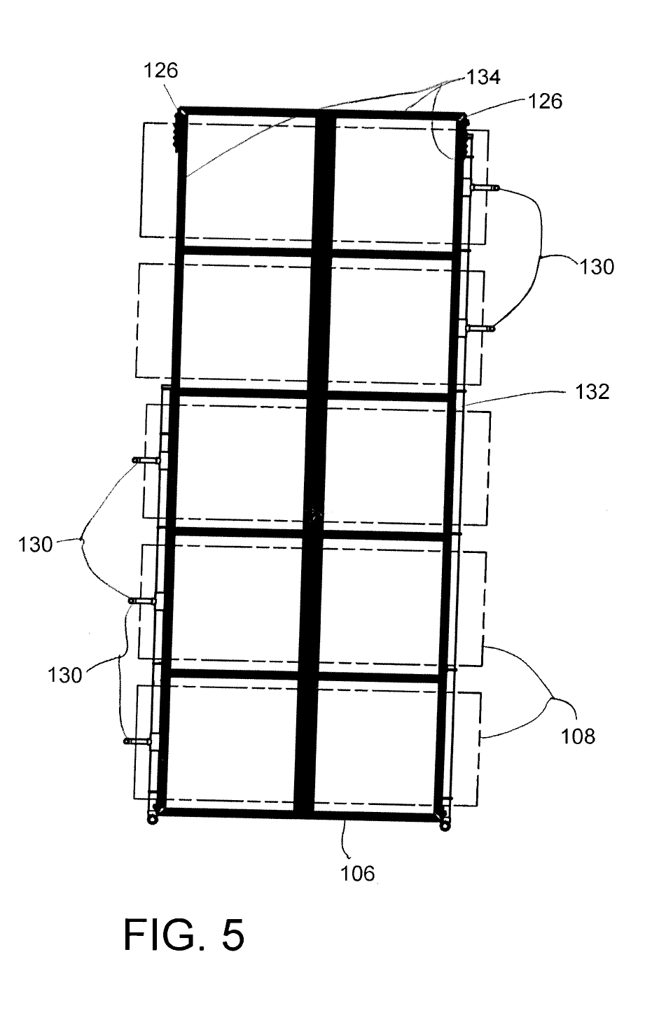

FIGS. 1 and 5 show the non-floating supporting grid 106 according to one embodiment of the present invention. The plurality of gas diffuser panels 108 in FIG. 1 is shown in solid lines while the diffuser panels 108 are shown in phantom lines in FIG. 5. The supporting grid 106 may be a structure comprising one or more structural members 134 constructed such that the plurality of gas diffuser panels 108 mounted thereon are connected in a positionally fixed relationship relative to each other. The supporting grid 106 may be constructed to support any number of gas diffuser panels 108, such as two, three, four, five, ten, twenty, one hundred, or any integer therebetween, or more than one hundred. The gas diffuser panels 108 are fixedly connected to the supporting grid 10 6 at attachment points in which the supporting grid 106 is directly attached to the aeration portions 202 of the gas diffuser panels 108 or the supporting grid 106 is connected to the structural frame 204 of the gas diffuser panel 108, if present, using any suitable fastening device, such as bolts, anchor rods, cables, etc.

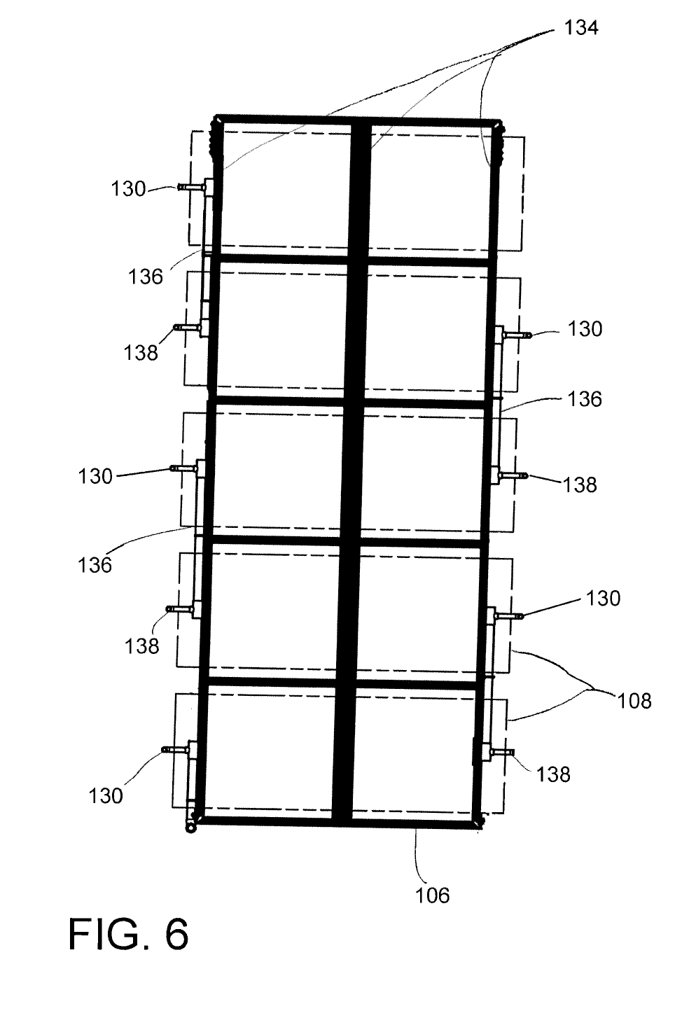

The supporting grid 106 can be made from a variety of suitable materials, such as metal, plastic (such as PVC) or any combination thereof. The material of the supporting grid may preferably have a specific gravity greater than the medium into which it will be submerged such that aeration assembly 100 (with its gas diffuser panels and supporting grid) will sink to the bottom of the receptacle 104 so as to sit on the floor 600 of the receptacle 104. Also, the structural members 134 may take any suitable construction, such as hollow tubes or piping, hollow or solid beams, material sheets, c-channels, or other suitable structure. Further, the supporting grid 106 may be any suitable shape. For example, FIGS. 5 and 6 show embodiments of the supporting grid 106 being in a rectangular shape.

Referring to FIG. 1, the supporting grid 106 may have at least two ends, such as, for example, a first end 110 and a second end 112. The supporting grid 106 may also include one or more gas inlets 114 affixed to one of the at least two ends, such as the first end 110 in FIG. 1, for supplying gas to the plurality of gas diffuser panels 108. The gas inlets 114 are in fluid communication with one or more gas flow tubes 132, which are, in turn, in fluid communication with the feed tubes 130. According to the embodiments of FIGS. 1 and 5, there are two gas inlets 114 connected to two gas flow tubes 132. One gas tube is connected to three feed tubes 130 and another gas tube is connected to two feed tubes 130. Each of the feed tubes 130 are connected to a corresponding gas inlet 218 of an aeration portion 202 of an gas diffuser panel 108 mounted on the supporting grid 106.

According to another embodiment of the present invention, the supporting grid 106 may include two ends 111 and 113, which are depicted in FIG. 1 as being the sides between the first end 110 and the second end 112. In addition to or alternative to the one or more gas inlets being affixed to one of the at least two ends 110 and 112, the one or more gas inlets 114 may be affixed to one, two, or three of the other of the at least two ends 110 and 112, the third end 111, and the fourth end 113 of the supporting grid 106 for supplying gas to the plurality of gas diffuser panels 108.

Other embodiments of the present invention include: (1) one inlet 114 connected to one gas flow tube 132, the gas flow tube 132 being connected to all the feed tubes 130 (along one side of the aeration assembly) which are each connected to a corresponding gas inlet 218 of the aeration portions 202; (2) a plurality of inlets 114 in which each inlet 114 is connected to its own gas flow tube 132, each gas flow tube 132 being connected to only one feed tube 130 connected to a corresponding gas inlet 218 of an aeration portion 202; and (3) one inlet 114 connected to a plurality of gas flow tubes 132, each gas flow tube 132 being connected to one or more feed tubes 130 connected to a corresponding gas inlet 218 of an aeration portion 202. The gas flow tube(s) 132 may be mounted or fixedly attached to a structural member 134 of the supporting grid 106 by brackets or other suitable fastening mechanisms.

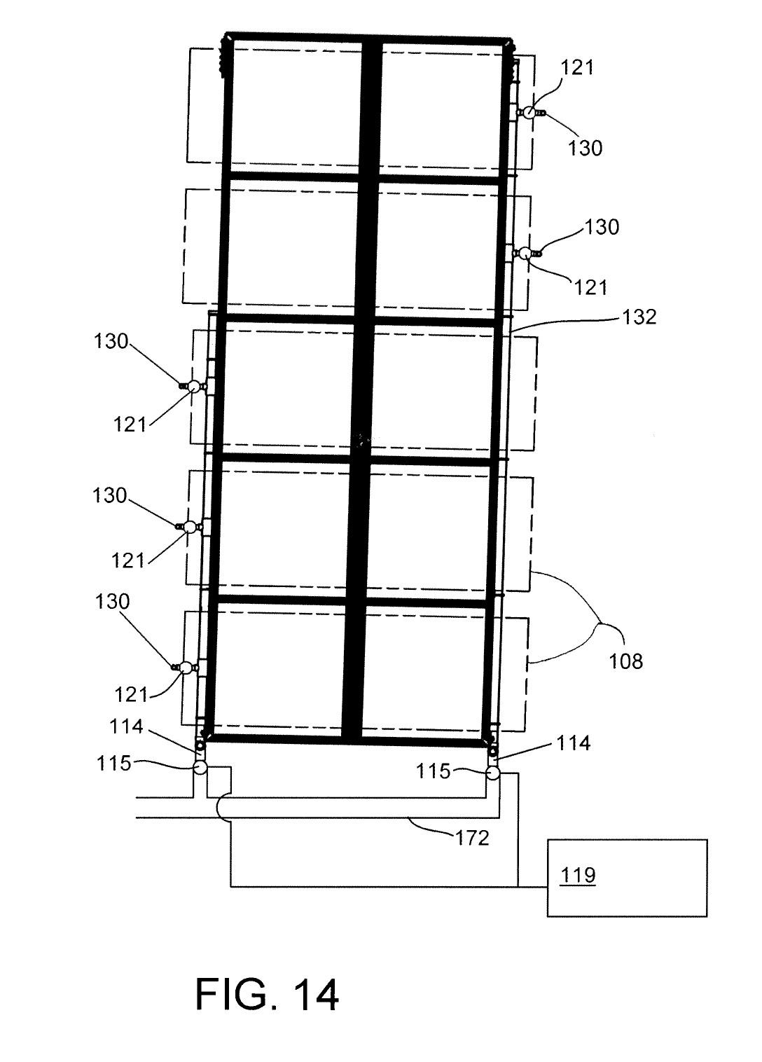

A preferred embodiment of the present invention is shown schematically in FIG. 14 in which the one or more gas inlets 114 comprises a first gas inlet in fluid communication with a first portion of the plurality of gas diffuser panels, and a second gas inlet in fluid communication with a second portion of the plurality of gas diffuser panels. A first valve 115 is configured to control the flow of gas through the first portion and a second valve 115 is configured to control the flow of gas through the second portion. Other embodiments of the present invention may include more than two inlets 114 with each inlet in fluid communication with a corresponding valve 115 so as to control flow through its respective inlet. With at least two inlets per aeration assembly, for example, a valve 115 can be placed in line with each inlet 114 so that gas flow to a portion of the aeration assembly (such as one, two, or three of the panels) can be controlled so as to shut off the gas flow to the portion of the aeration assembly without shutting off the gas flow to all the panels 108 of the entire aeration assembly. The valves 115 may be operated manually or through the use of a controller 119 (the controller 119 being used to control the operation of the gas source 140). In addition to or alternative to the valves 115 for each inlet 114, there can be valves 121 for each feed tube 130 to control the gas flow to a portion (that is, one panel) of the aeration assembly so as to shut off the gas flow to the portion of the aeration assembly without shutting off the gas flow to all the panels of the entire aeration assembly.

FIG. 6 shows another embodiment of the supporting grid 106 in which gas flow through the gas diffuser panels 108 is performed serially using feed tubes 130, connecting gas tubes 136, and outlet tubes 138. In this embodiment, each gas diffuser panel 108 (shown in phantom lines) has a gas inlet 218, a gas outlet, and perforations in the upper portion. The gas outlets of the gas diffuser panels 108 are each connected to a corresponding outlet tube 138. Each connecting gas tube 136 connects an outlet tubes 138 of one gas diffuser panel 108 to the feed tube 130 connected to the gas inlet of an adjoining gas diffuser panel. Thus, the gas flow through the gas diffuser panels mounting on the supporting grid are performed serially. The connecting gas tubes 136 may be mounted or fixedly attached to a structural member 134 of the supporting grid 106 by brackets or other suitable fastening mechanisms.

In the embodiments of FIGS. 5 and 6, the feed tubes 130, outlet tubes 138, connecting gas tubes 136, and gas flow tube 132 may be of any suitable construction. For example, these tubes may be piping, tubing, ducting, or any suitable channel that permits the flow of gas or other gas therethrough for delivery of the gas or gas to the gas diffuser panels 108 via their respective gas inlets 218.

The gas inlets 114 for each supporting grid 106 may be connected to a gas source 140 (shown in FIG. 3) for providing gas to the aeration portions 202 of the gas diffuser panels 108. The gas may be, for example, air, oxygen, or other suitable gas. By air, it is meant that a gas or mixture in which a significant portion of said gas or mixture is air. For example, 5, 10, 20, 40, 80, 100% or any integer therebetween of the mixture or gas may be air. By oxygen, it is meant that a gas or mixture in which a significant portion of said gas or mixture is oxygen. For example, 5, 10, 20, 40, 80, 100% or any integer therebetween of the mixture or gas may be oxygen. According to various embodiments of the present inventions, the gas source 140 can supply gas to a biological wastewater treatment plant and/or a lake depleted, or in need, of certain gaseous nutrients, such as oxygen. The gas source 140 can be, for example, a blower 142 or one or more tanks of compressed gas. The gas source 140 may be in fluid connection with the gas inlets 114 of each aeration assembly using suitable gas channeling equipment 144, such as, for example, piping, tubing, ducting, or other suitable channels used to permit the flow of air or other gas therethrough. For example, FIG. 3 shows the use of piping 172 for connecting the blower 142 to the gas inlets 114. The gas inlets 114 may be detachable from the piping 172.

The aeration assembly 100 may comprise one or more placement guides 124. The placement guides 124 may be posts that protrude upward from the supporting grid 106. The placement guides 124 in FIGS. 1, 2, and 3 have a bottom end 146 attached to the supporting grid 106, a top end 148, and a marker 150. The posts may be flexible or inflexible, and may be made of any suitable material. If the guides 124 are flexible posts (such as rope or sheet metal), the marker 150 may be a buoy so that the markers 150 may be seen at the surface of the wastewater 102. If the guides 124 are inflexible, the marker may simply be an attachment (such a colored cylinder) that may be seen at the surface of the wastewater. The placement guides may permit an operator to view the placement of the aeration assembly 100 in the receptacle 104.

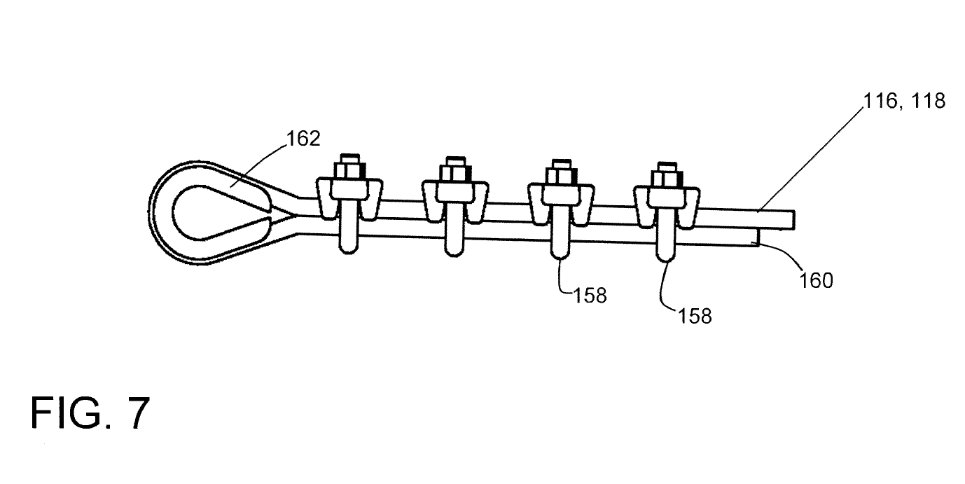

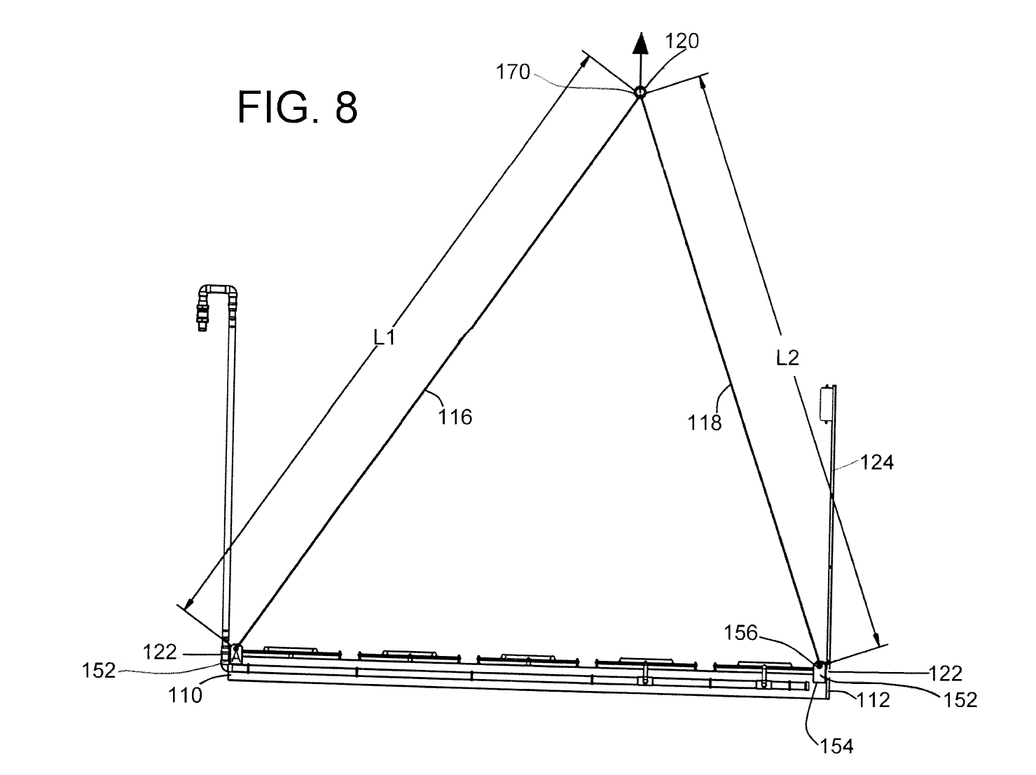

The supporting grid 106 may also include one or more lift lines 116, 118 of a predetermined length affixed to each of the at least two ends 110 and 112 with all lift lines meeting at a juncture 120. FIGS. 3 and 8 show two lift lines 116 are affixed to the first end 110 and two lift lines 118 are affixed to the second end 112 such that a lift line is affixed at or near each corner 126 of the supporting grid 106. Of course, the lift lines 116 and 118 may be at any suitable location on the supporting grid 106. The lift lines 116 and 118 may be connected to their respective ends of the supporting grid 106 using brackets 152. Each bracket 152 is fixedly attached to the structural members 134 of the supporting grid 106. The bracket 152 may be connected to its corresponding structural member at one end 154. At the other end, the bracket 152 may comprise a hole 156. The respective lift lines 116 and 118 (which may, for example, be cables, rods, or a combination thereof) are fed through the hole 156 and one end 160 of the lift line is attached to another portion of the lift line using cable clips 158, as shown FIG. 7. A protective grommet 162 may be used to protect the lift line 116, 118 from being worn by the inner edge of the hole 156 of the bracket 152 once the lift lines 116, 118 are attached to their respective brackets 152. According to other embodiments, the attachment of the lift lines to the supporting grid 106 may any suitable attachment mechanism, such as, for example, other types of brackets.

According to one embodiment shown in FIGS. 3 and 8, the two lift lines 116 may be each affixed to an adjacent corner at the first end 110 while the two lift lines 118 may be each affixed to an adjacent corner at the first end 112. The two lift lines 116 may be substantially the same predetermined length L1 while the two lift lines 118 may be substantially the same predetermined length L2. Further, the predetermined length L1 of the lift line 116 affixed to one of the at least two ends 110 is unequal to the predetermined length L2 of the lift line 118 affixed to the other of the at least two ends 112 when the juncture 120 is positioned above the plane 122 of the supporting grid 106. For example, the predetermined length L1 may be longer than the predetermined length L2, as seen in FIGS. 3 and 8, or vice versa. According to other embodiments of the present invention, the predetermined length L1 may be the same length as the predetermined length L2.

According to further embodiments of the present invention, one lift line 116 may be fed through the juncture 120 with each end of the lift line 116 being affixed to an adjacent corner at the first end 110 while one lift line 118 may be fed through the juncture 120 with each end of the lift line 118 being affixed to an adjacent corner at the second end 112. The lift line 116 may have a predetermined length (2×L1) while the lift line 118 may have a predetermined length (2×L2). With this configuration, L1 can be substantially equal to L2, greater than L2 or less than L2. Alternatively, one lift line 116 may be fed through the juncture 120 with one end of the lift line 116 being affixed to a corner at the first end 110 and another end of the lift line 116 being affixed to a corner at the second end 112. Similarly, the lift line 118 may be fed through the juncture 120 with one end of the lift line 118 being affixed to a corner at the first end 110 and another end of the lift line 118 being affixed to a corner at the second end 112.

The juncture 120 may take any suitable form. In FIGS. 3 and 8, the juncture 120 is shown to have a connection 170 in the form of a ring through which the one or more lift lines 116, 118 are attached therethrough. The juncture may take any suitable form such as a bracket with apertures, a clamp, a post, or other suitable attachment mechanism to which the lift lines 116, 118 are connected, attached, or affixed. The juncture 120 may be positioned above the plane 122 of the supporting grid 106. When the aeration assembly 100 is placed in the receptacle 104, as shown in FIG. 3, the juncture 120 may be attached to an anchor post 164 protruding from an upper edge of one of the side walls 604 of the receptacle 104 so that the juncture 120 may be easily retrieved in the event that the aeration assembly 100 needs to be removed from the receptacle 104.

FIG. 2 shows a plurality of aeration assemblies 100 submersed in wastewater 102 in a receptacle 104 according to one embodiment of the present invention while FIG. 3 shows a plurality of aeration assemblies 100 submersed in wastewater 102 in a receptacle 104 according to another embodiment of the present invention. Both FIGS. 2 and 3 show two or more aeration assemblies 100 positioned on the floor 600 of the receptacle 104. Each aeration assembly 100 is capable of being lifted from the floor 600 of the receptacle 104 using the lines 116 and 118 while the other aeration assemblies 100 remain on the floor 600 of the receptacle 104. This is accomplished because each aeration assembly has its own connection to the gas source 140 via their respective inlets 114 being connecting to the gas channeling equipment 144. The disconnection of one aeration assembly still permits the operation of the other aeration assemblies in the receptacle 104 due to their continued connection to the gas source 140. As a result, the other aeration assemblies 100 may remain in operation on the floor 600 of the receptacle while the one of the aeration assemblies is removed from the receptacle for maintenance or replacement work.

The difference between FIG. 2 and FIG. 3 is simply the arrangement and number of the aeration assemblies in the receptacle 104. According to other embodiments of the present invention, any number of aeration assemblies (such as, for example, two, three, four, five, ten, twenty, one hundred, or any integer therebetween, or more than one hundred) may be placed in the receptacle 104 in any desirable configuration. Examples of suitable configurations may be aeration assemblies in an array of m×n in which m and n are any suitable integers. The rows and/or columns of the array may be aligned, staggered, or any other suitable pattern.

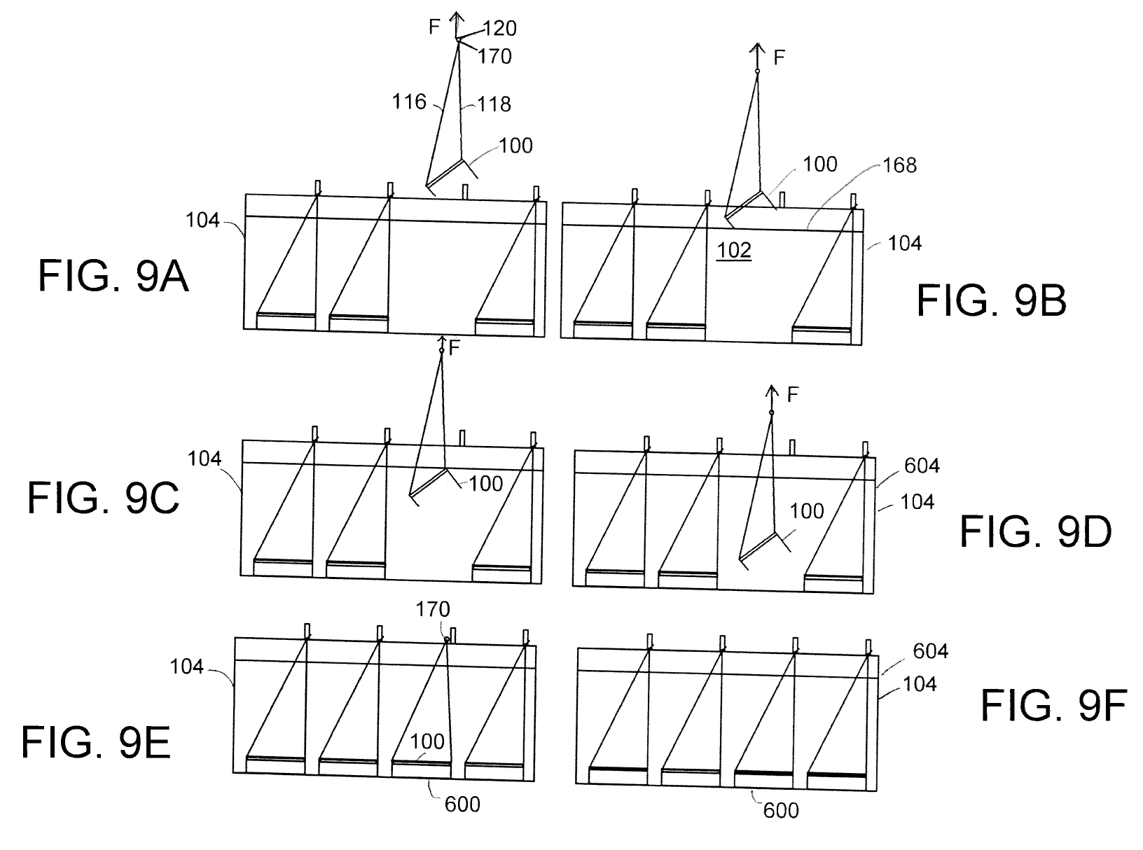

The method of installing the aeration assemblies 100 into the receptacle 104 will now be explained with reference to FIGS. 9A-9F. The method of lowering an aeration assembly 100 into the receptacle 104 is used to install the aeration assembly 100 into the treatment system. The aeration assembly 100 may comprise a non-floating planar grid 106 supporting a plurality of gas diffuser panels 108, the supporting grid 106 having at least two ends 110 and 112, each end affixed to one or more lift lines 116 and 118 of a predetermined length with all lift lines meeting at a juncture 120. The method may first comprise suspending the aeration assembly 100 above the receptacle 104 by applying a force F to the juncture 120, which is sufficient to overcome gravity, as seen in FIG. 9A. A crane, wench, pulley, or other type of lifting device may be used to lift the aeration assembly at the connection 170. The suspension may be of such a nature that the predetermined length of the lift line 116 affixed to one of the at least two ends 110 is unequal to the predetermined length of the line 118 affixed to another of the at least two ends 112 as the juncture 120 is positioned above the plane 122 of the supporting grid 106.

The method further comprise lowering the suspended aeration assembly 100, while continuing to apply the force to the juncture 120, into the receptacle 104, as seen in FIG. 9B. This lowering is continued until one of the at least two ends of the supporting grid 106 breaks a top surface 168 of the wastewater 102 contained in the receptacle 104. The lowering is further continued until the aeration assembly 100 is lowered to a position on the floor 600 of the receptacle 104, as shown in progression from FIGS. 9C through 9F. The one or more inlets 114 of the lowered aeration assembly 100 then may be connected to the gas channeling equipment 144 in fluid communication with the gas source 140. The operation of the aeration assembly may commence, regardless of the status of the other aeration assemblies in the receptacle 104.

If an aeration assembly 100 needs to be removed because it requires maintenance, repair, or replacement, the method of lifting or removing the aeration assembly positioned on the floor 600 of the receptacle 104 may be used. Even though one aeration assembly is removed, the other assemblies can still remain in operation. For example, two or more aeration assemblies (for example, two, three, ten, or fifteen assemblies) may be positioned on a floor of the receptacle with each aeration assembly capable of being operated such that gas is permitted to flow through at least one aeration assembly (for example, most of the assemblies) while gas flow through another aeration assembly is shut off so that it can be removed. Thus, while one or more aeration assembly can be removed, the remaining assemblies can remain in operation.

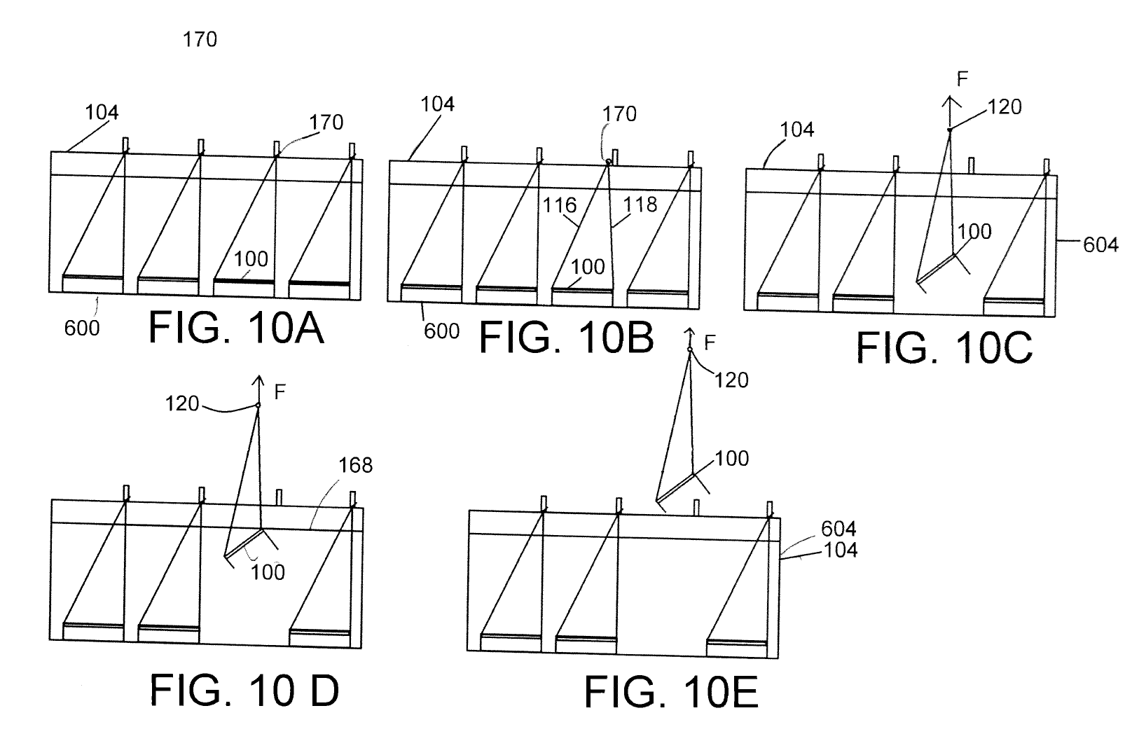

The aeration assembly 100 may comprise a non-floating planar grid 106 supporting a plurality of gas diffuser panels 108, the supporting grid 106 having at least two ends 110 and 112, each end affixed to one or more lift lines 116 and 118 of a predetermined length with all lift lines meeting at a juncture 120. The method of removing the aeration assemblies 100 from the receptacle 104 will now be explained with reference to FIGS. 10A-10E. The one or more inlets 112 of the aeration assembly 110 may be disconnected from the gas channeling equipment 144 in fluid communication with the gas source 140 while the other aeration assemblies remain connected to the gas channeling equipment 144. As seen in FIGS. 10A and 10B, the method may comprise providing a connection 170 to the juncture 120 such that the predetermined length of a lift line 116 affixed to one of the at least two ends 110 is unequal to the predetermined length of a lift line 118 affixed to another of the at least two ends 112 when the juncture 120 is positioned above the plane 122 of the supporting grid 106.

After providing the connection 170, the method then comprises applying a force F to the juncture 120, using the connection 170, sufficient to lift the aeration assembly 100 from its position on the floor 600 of the receptacle 104, as seen in FIG. 10C. The force may be from a crane, wench, pulley, or other lifting device sufficient to lift the aeration assembly 100 from the receptacle 104 against the force of gravity. The force is applied until one of the at least two ends 110, 112 of the supporting grid 106 emerges from the top surface 168 of the wastewater 102 contained in the receptacle 104, as seen in FIG. 10D. If the lift line(s) of one end of the aeration assembly 100 is shorter than the lift line(s) at the other end (that is, the lift lines are of unequal length), then one end of the aeration assembly 100 will emerge from the wastewater 102 before the other end of the aeration assembly 100 because the aeration assembly is being lifted at a non-zero angle from the horizontal plane. Such a non-zero angle may permit the liquid above the top surface of the gas diffuser panels to flow off the aeration assembly 100 more readily during lifting. Then, in FIG. 10E, the force F is applied until the aeration assembly 100 is lifted above the edges of the side wall 604 of the receptacle 104. Even though the aeration assembly 100 is removed from the receptacle 104, the other aeration assemblies in the receptacle 104 remain in operation.

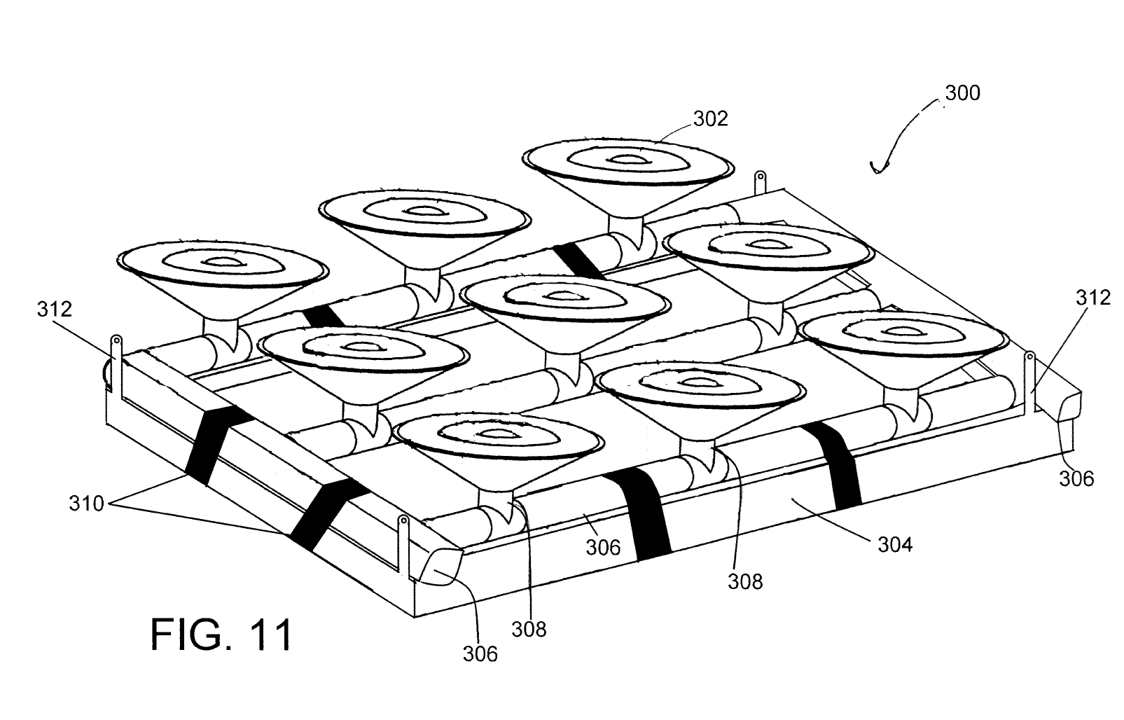

Other embodiments of the present invention are also contemplated. FIG. 11 shows an aeration assembly 300 with circular gas diffusers panels 302 connected to a supporting grid 304. The supporting grid 304 supports a grid of gas flow channels 306 which are in fluid communication with the gas inlets 308 of the gas diffuser panels 302. The flow channels 306 may be affixed to the grid 304 by fastening devices 310, such as straps, clamps, bolts, or other suitable fasteners. The gas flow channels then can be connected in fluid communication to the gas source via gas inlets (not shown). Also, the lift lines may be connected to their respective ends of the supporting grid 304 using brackets 312 attached to the grid 304. The brackets 312 may be affixed to the grid in any number of suitable methods, such as by screws, welding, brazing, clamping or the like.

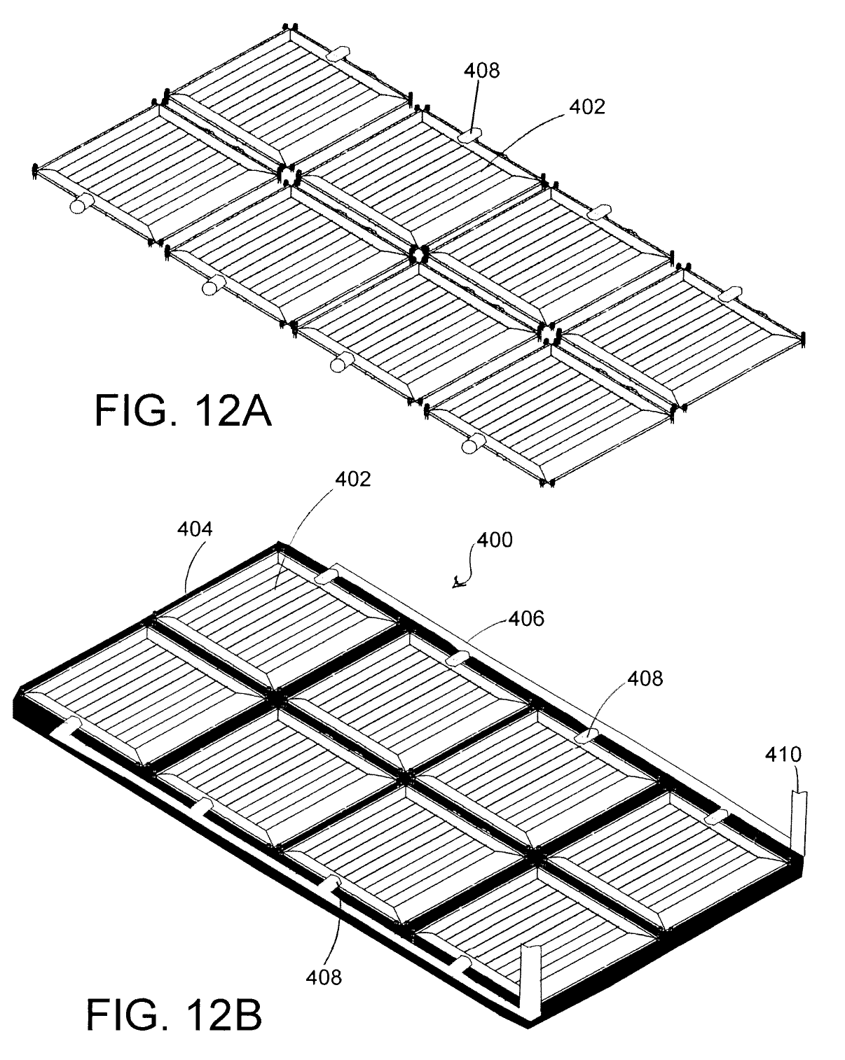

FIG. 12A shows a plurality of square gas diffuser panels 402 to be used in the aeration assembly 400 shown in FIG. 12B. The panels 402 are mounted on a supporting grid 404. The supporting grid 404 includes several beam members connected to each other. The beam members may be connected by welding, bolting, or by other suitable fastening mechanism. Gas flow channels 406 are in fluid communication with the gas inlets 408 of the gas diffuser panels 402. The gas flow channels then can be connected in fluid communication to the gas source via gas inlets 410 (partially shown in FIG. 12B).

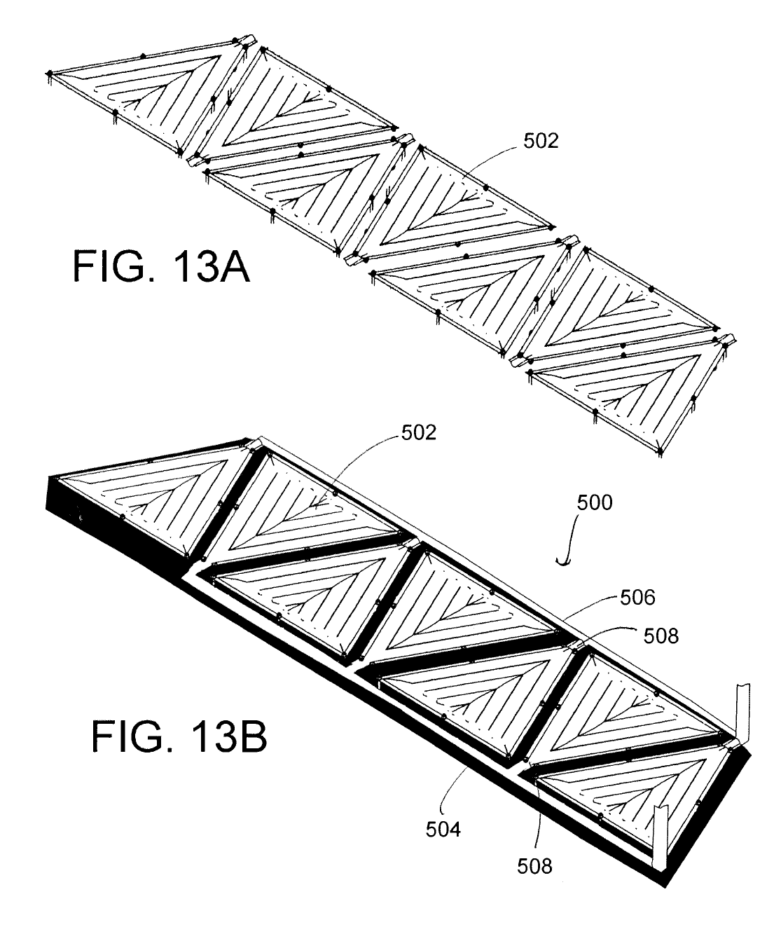

FIGS. 13A shows a plurality of triangular gas diffuser panels 502 to be used in the aeration assembly 500 shown in FIG. 13B. The panels 502 are mounted on a supporting grid 504. The supporting grid 504 includes several beam members connected to each other. The beam members may be connected by welding, bolting, or by other suitable fastening mechanism. Gas flow channels 506 are in fluid communication with the gas inlets 508 of the gas diffuser panels 502. The gas flow channels then can be connected in fluid communication to the gas source via gas inlets 510 (partially shown in FIG. 13B).

The embodiments of FIGS. 11, 12A-12B, and 13A-13B may also include the lift lines, the placement guides, and any other feature from any other embodiment of the aeration panel previously mentioned.

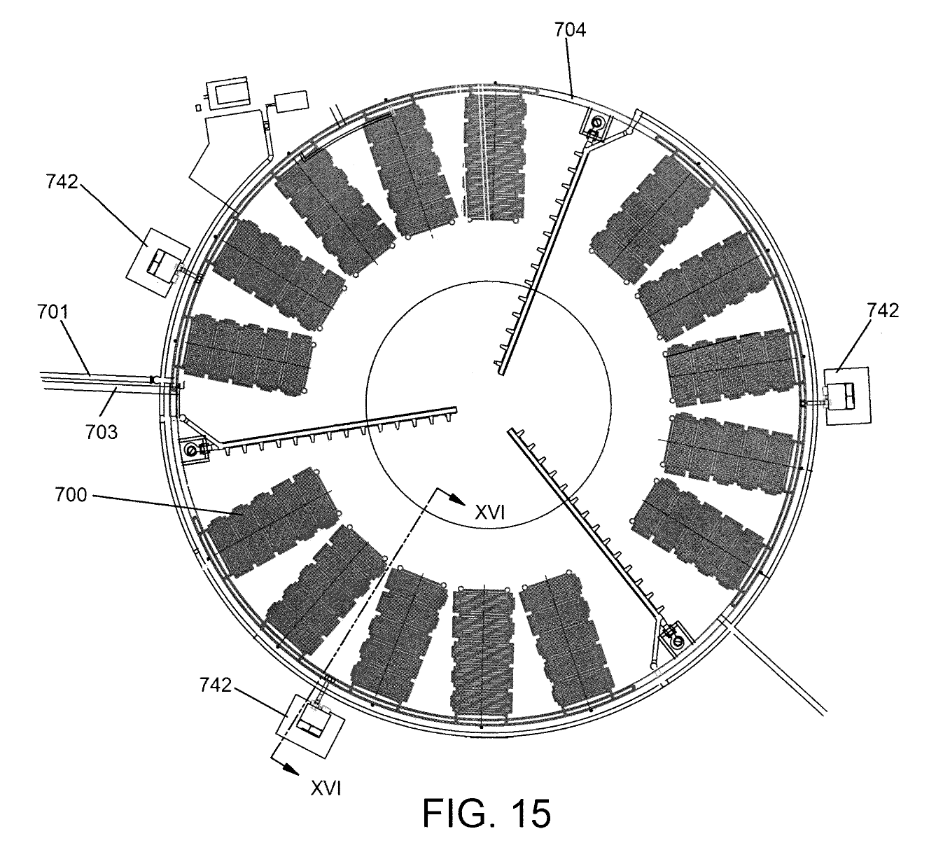

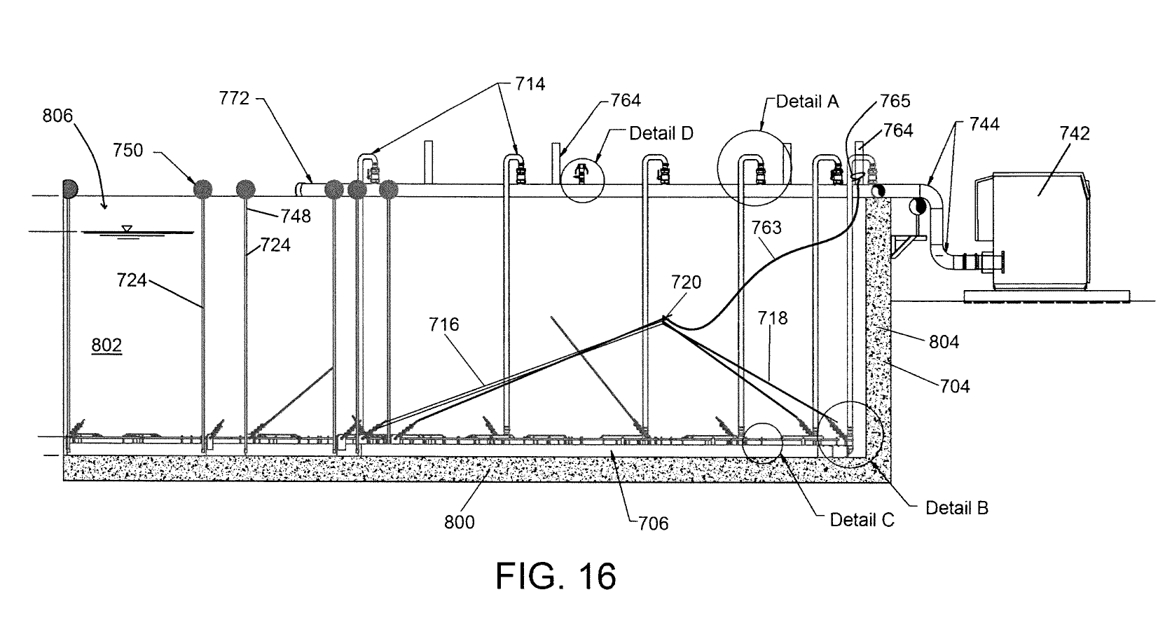

Another embodiment of the present invention is shown in FIG. 15, which shows an aerial view of a plurality of aeration assemblies 700 submersed in a receptacle 704. FIG. 16 shows a cross sectional view taken along line XVI-XVI of FIG. 15. FIG. 26 shows a perspective view of the aeration assembly from the embodiment of FIG. 16.

FIG. 15 shows a cylindrical receptacle 704 with fifteen independent assemblies 700. Also, each assembly of this embodiment has five panels 708. One of the blowers 742 (which is a gas source) is connected to each assembly. The receptacle 704 may be used as a nitrification reactor with a sludge return 701 and an inlet for the influent 703 to be treated.

The receptacle 704 may be a concrete basin, a metal tank, a vessel, reservoir, lake, or other structure used to contain liquid. For example, the receptacle 704 may have a floor or bottom wall 800 and a side wall 804 protruding vertically from the floor 800 so as to form a space 802 bounded by the floor 800 and the side wall 804. An opening 806 is formed by the periphery of the side wall 804 at the upper end of the receptacle 704 so that access to the space 802 can be obtained.

The wastewater 102 may be any suitable liquid or mixture in which water is a significant component. For example, 5, 10, 20, 40, 80, 100% or any integer therebetween of the mixture may be water.

Each aeration assembly 700 may comprise a non-floating supporting planar grid 706 supporting a plurality of gas diffuser panels 708. FIG. 4 shows one suitable gas diffuser panel according to one embodiment of the present invention. Gas can be delivered to the flexible aeration portion of the gas diffuser panel using a feed tube 730, such as shown in FIG. 26.

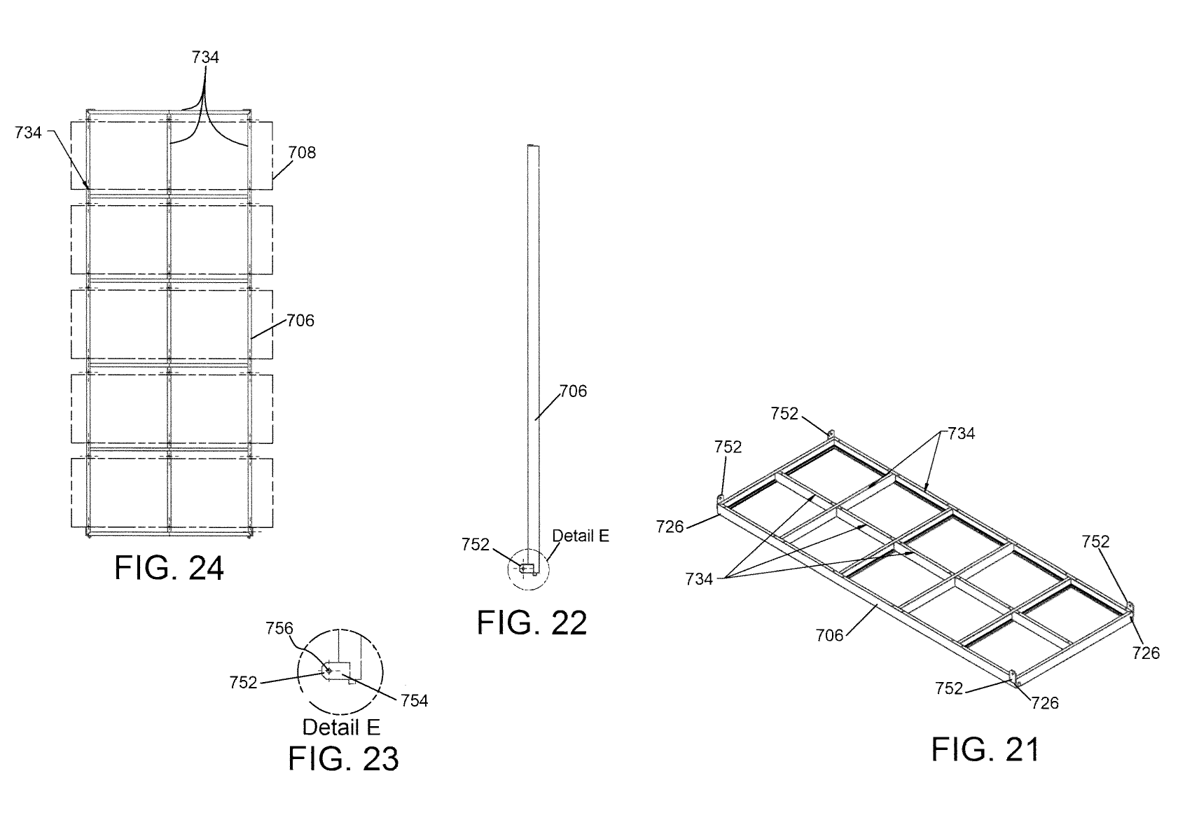

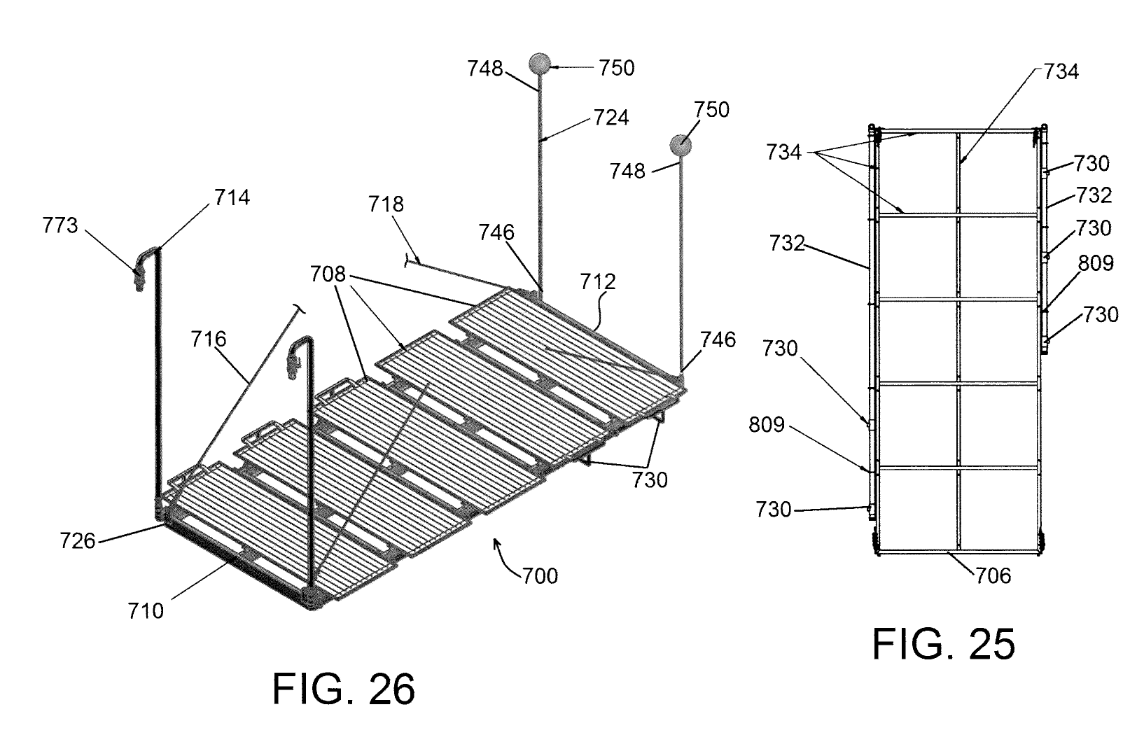

FIGS. 21-24 show detailed views of the planar grid 706 according to the embodiment shown in FIG. 16 while FIG. 25 shows the planar grid of FIG. 21 with gas flow tubes. The plurality of gas diffuser panels 708 in FIG. 26 is shown in solid lines while the diffuser panels 708 are shown in phantom lines in FIG. 24. The supporting grid 706 may be a structure comprising one or more structural members 734 constructed such that the plurality of gas diffuser panels 708 mounted thereon are connected in a positionally fixed relationship relative to each other. The supporting grid 706 may be constructed to support any number of gas diffuser panels 708, such as two, three, four, five, ten, twenty, one hundred, or any integer therebetween, or more than one hundred.

FIGS. 16 18, and 19 show the mechanism by which a gas diffuser panels 708 are fixedly connected to the supporting grid 706 according to an embodiment of the invention. There are apertures in either the gas diffuser panel 708 or in an optional structural frame which surrounds and supports the gas diffuser panel. A stand off member 810 attached to the structural member 734 of the supporting grid is fed through the apertures. The standoff member 810 may comprise a threaded rod with a resting member 812 (such as, for example, a bolt and/or plate) disposed thereon. The standoff member may be secured to the structural member 734 by any suitable mechanism, such as, for example, being affixed by bolts, welding, soldering, adhesive, etc. Also, the resting member may be a separate component affixed to the standoff member 810 or may be integrally formed with the standoff member as one-piece. The gas diffuser panel 708 rests on the resting member 812 with the standoff member 810 protruding through the corresponding aperture in the gas diffuser panel 708 or structural frame. A clamping member 814 clamps the gas diffuser panel 708 between itself and the resting member, thus securing the panel 708 to the supporting grid 706. The clamping member 814 may be a bolt, c-clamp, or any other suitable fastening mechanism. Additionally or alternatively, any suitable fastening device, such as bolts, anchor rods, cables, etc., can be used to affix the gas diffuser panel to the supporting grid.

The supporting grid 706 can be made from a variety of suitable materials, such as metal, plastic (such as PVC), concrete, or any combination thereof. The material of the supporting grid may preferably have a specific gravity greater than the medium into which it will be submerged such that aeration assembly 700 (with its gas diffuser panels and supporting grid) will sink to the bottom of the receptacle 704 so as to sit on the floor 800 of the receptacle 704. Also, the structural members 734 may take any suitable construction, such as hollow tubes or piping, hollow or solid beams, material sheets, c-channels, or other suitable structure.

Referring to FIG. 26, the supporting grid 706 may have at least two ends, such as, for example, a first end 710 and a second end 712. The supporting grid 706 may also include one or more gas inlets 714 affixed to one of the at least two ends, such as the first end 710 in FIG. 26, for supplying gas to the plurality of gas diffuser panels 708. The gas inlets 714 are in fluid communication with one or more gas flow tubes 732, which are, in turn, in fluid communication with the feed tubes 730. According to the embodiments of FIGS. 25 and 26, there are two gas inlets 714 connected to two gas flow tubes 732. One gas tube is connected to three feed tubes 730 and another gas tube is connected to two feed tubes 730. The gas flow tubes 732 may be mounted or fixedly attached to a structural member 734 of the supporting grid 106 by brackets 809 or other suitable fastening mechanisms.

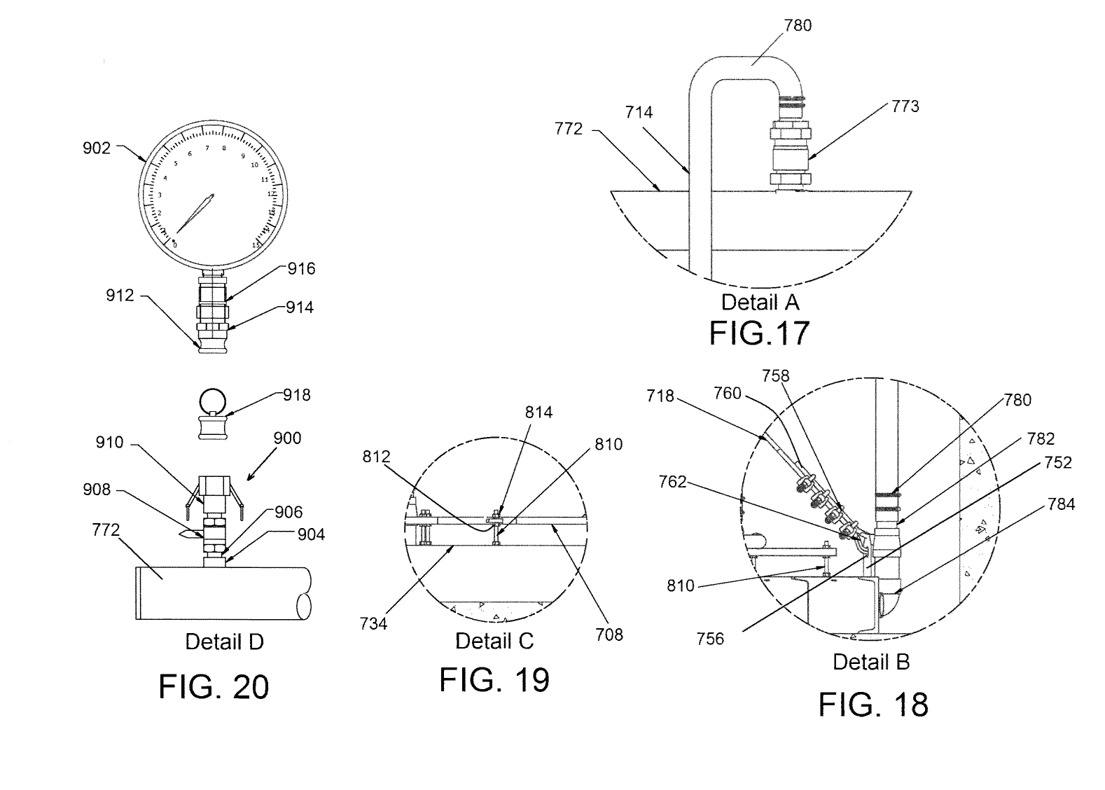

As seen in FIG. 16, the gas inlets 714 for each supporting grid 706 may be connected to the blower 742 for providing gas to the aeration portions of the gas diffuser panels 708. The blower 742 may be in fluid connection with the gas inlets 714 of each aeration assembly using suitable gas channeling equipment 744, such as, for example, piping, tubing, ducting, or other suitable channels used to permit the flow of air or other gas therethrough. For example, FIG. 16 shows the use of piping 772 for connecting the blower 742 to the gas inlets 714. FIG. 17 shows that the gas inlets 714 may be detachable from the piping 772 using any suitable fitting 773, such as, for example, a pipe fitting, a quick fitting, a hydraulic fitting, or any other suitable mechanism that has mating components between the piping 772 and the gas inlet 714.

The gas inlets 714 may be a unitary structure or a multi-component structure that comprises a first member 780, a fitting 782, and a second member 784. The first member 780 connects to the piping 772 via the fitting 773 and to the second member 784 via the fitting 782. The fitting 782 may be any suitable fitting, such as, for example, a pipe fitting, a quick fitting, a hydraulic fitting, or any other suitable mechanism that has mating components between the first member 780 and the second member 784. The second member 784 engages the gas flow tube 732 so as to deliver gas through the first member 780 to the gas diffuser panel 708. Alternatively, the second member 784 may be eliminated, and the first member 780 may connect directly to the gas flow tube 732.

FIG. 20 shows the use of an optional pressure gauge connection 900 from the embodiment of FIG. 16. The pressure gauge connection is used to connect a pressure gauge 902 to the piping 772 which connects the blower 742 to the gas inlets 714. According to one embodiment, the pressure gauge connection includes a half inch coupling 904, a one inch pipe 906, a one inch valve 908, and a one inch male coupler 910. The pressure gauge 902 may have a dust cap 912, a one inch female coupler 914, and a bushing 916. Furthermore, a dust plug 918 may also be used. Other types of pressure gauges (such as, for example, digital sensors) and connections may be used as well.

The aeration assembly 700 may comprise one or more placement guides 724. The placement guides 724 may be posts that protrude upward from the supporting grid 706. The placement guides 724 in FIGS. 16 and 26 have a bottom end 746 attached to the supporting grid 706, a top end 748, and a marker 750. The posts may be flexible or inflexible, and may be made of any suitable material. The marker 750 may be a buoy or sphere, and may be colored so as to permit an operator to view the placement of the aeration assembly 700 in the receptacle 704.

The supporting grid 706 may also include one or more lift lines 716, 718 of a predetermined length affixed to each of the at least two ends 710 and 712 with all lift lines meeting at a juncture 720. FIGS. 16 and 26 show two lift lines 716 are affixed to the first end 710 and two lift lines 718 are affixed to the second end 712 such that a lift line is affixed at or near each corner 726 of the supporting grid 706. The lift lines 716 and 718 may be connected to their respective ends of the supporting grid 706 using brackets 752, as seen in FIGS. 21-23. Each bracket 752 is fixedly attached to the structural members 734 of the supporting grid 706. The bracket 752 may be connected to its corresponding structural member at one end 754 by any suitable mechanism, such as, for example, adhesive, welding, soldering, nuts and bolts, etc. At the other end, the bracket 752 may include a hole 756.

FIG. 18 shows that the respective lift lines 716 and 718 (which may, for example, be cables, rods, or a combination thereof) are fed through the hole 756 of the bracket 752 and one end 760 of the lift line is attached to another portion of the lift line using cable clips 758, the details of which are more clearly shown in FIG. 7. A protective grommet 762 may be used to protect the lift line 716, 718 from being worn by the inner edge of the hole 756 of the bracket 752 once the lift lines 716, 718 are attached to their respective brackets 752. The lengths of the lift lines 716 and 718 may be any suitable length, for example, one of the lengths or configurations as previously discussed in relation to the embodiment shown in FIGS. 3 and 8.

The juncture 720 may take any suitable form, such as, for example, a connection in the form of a ring (as seen in FIG. 8), a bracket with apertures, a clamp, a post, or other suitable attachment mechanism to which the lift lines 716, 718 are connected, attached, or affixed. The juncture 720 may be positioned above the plane of the supporting grid 706. When the aeration assembly 700 is placed in the receptacle 704, as shown in FIG. 16, another lift line 763 connects the juncture 720 to an anchor post 764 protruding from an upper edge of the side wall 804 of the receptacle 704. The end 765 of the lift line 763 may be formed into a loop so as to be placed about the anchor post 764 or the end 765 of the lift line 763 may have some attachment (such as, for example, a ring, clamp, or other mechanism) for securing the end 765 to the anchor post 764 or other location outside the receptacle 704. Thus, the end 765 of the lift line 763 may be easily retrieved in the event that the aeration assembly 700 needs to be removed from the receptacle 104.

FIGS. 15 and 16 show a plurality of aeration assemblies 700 submersed in wastewater in the receptacle 704 according to one embodiment of the present invention. The two or more aeration assemblies 700 are positioned on the floor 800 of the receptacle 704. Each aeration assembly 700 is capable of being lifted from the floor 800 of the receptacle 704 using the lines 716, 718, and 763 while the other aeration assemblies 700 remain on the floor 800 of the receptacle 804. This is accomplished because each aeration assembly has its own connection to the gas source via their respective inlets 714 being connecting to the gas channeling equipment 744 via the piping 772 and their respective fittings 773, as seen in FIG. 17. The disconnection of one aeration assembly still permits the operation of the other aeration assemblies in the receptacle 704 due to their continued connection to the gas source. As a result, the other aeration assemblies 700 may remain in operation on the floor 800 of the receptacle while the one of the aeration assemblies is removed from the receptacle for maintenance or replacement work.

The method of installing the aeration assemblies 700 into the receptacle 704 is similar to the method shown in FIGS. 9A-9F as previously discussed. Once an aeration assembly 700 is installed, the operation of the aeration assembly may commence, regardless of the status of the other aeration assemblies in the receptacle 704. If an aeration assembly 700 needs to be removed because it requires maintenance, repair, or replacement, the method of lifting or removing the aeration assembly positioned on the floor 800 of the receptacle 704 may be used. The method of removing the aeration assemblies 700 from the receptacle 704 is similar to the method shown in FIGS. 10A-10E as previously discussed. Even though one aeration assembly is removed, the other assemblies can still remain in operation.

From the description of the embodiments presented above and below, the ability to provide a high efficiency aeration system as a retrofit or capacity increase (that is, increase in treatment capability), especially to small to medium sized installations, may be realized. The invention as described above and below could be installed without shutting down existing treatment systems while also providing a method of removing portions of the system for routine maintenance without shutting down the entire system or without a significant loss of overall treatment capacity.

Besides those embodiments depicted in the figures and described in the above description, other embodiments of the present invention are also contemplated. For example, any single feature of one embodiment of the present invention may be used in any other embodiment of the present invention. For example, an aeration assembly, a method of lifting an aeration assembly in a receptacle, and/or a method of lowering an aeration assembly into a receptacle may comprise any two or more of the following features in any combination:
a. an aeration assembly for submersion in and aeration of wastewater contained in a receptacle comprising a non-floating planar grid supporting a plurality of gas diffuser panels, the supporting grid having at least two ends;
b. one or more gas inlets affixed to one of the at least two ends for supplying gas to the plurality of gas diffuser panels;
c. one or more lift lines of a predetermined length affixed to each of the at least two ends with all lift lines meeting at a juncture;
d. the juncture being positioned above a plane of the supporting grid so that the predetermined length of a line affixed to one of the at least two ends is unequal to the predetermined length of a line affixed to another of the at least two ends;
e. one or more placement guides;
f. the supporting grid being rectangular;
g. two lift lines being affixed to each of the at least two ends, such that a lift line is affixed at or near each corner of the rectangular supporting grid;
h. two lift lines each affixed to an adjacent corner being of substantially the same predetermined lengths;
i. the one or more gas inlets comprises a first gas inlet in fluid communication with a first portion of the plurality of gas diffuser panels; and a second gas inlet in fluid communication with a second portion of the plurality of gas diffuser panels; and wherein a first valve is configured to control the flow of gas through the first portion and a second valve is configured to control the flow of gas through the second portion:
j. two or more aeration assemblies being positioned on a floor of the receptacle, each aeration assembly capable of being lifted from the floor of the receptacle while another remains on the floor of the receptacle;
k. two or more aeration assemblies being positioned on a floor of the receptacle, each aeration assembly capable of being lifted from the floor of the receptacle while another remains in operation on the floor of the receptacle;
l. two or more aeration being positioned on a floor of the receptacle, each aeration assembly capable of being operated such that gas is permitted to flow through at least one aeration assembly while gas flow through another aeration assembly is shut off;
m. lifting an aeration assembly positioned on a floor of a receptacle;
n. the supporting grid having at least two ends, each end affixed to one or more lift lines of a predetermined length with all lift lines meeting at a juncture;
o. providing a connection to the juncture such that the predetermined length of a lift line affixed to one of the at least two ends is unequal to the predetermined length of a line affixed to another of the at least two ends when the juncture is positioned above a plane of the supporting grid;
p. applying a force to the juncture, using the connection, sufficient to lift the aeration assembly from its position on the floor of the receptacle;
q. the force being applied until one of the at least two ends of the supporting grid emerges from a top surface of wastewater contained in the receptacle;
r. the force being applied until the aeration assembly is lifted above the receptacle;
s. lowering an aeration assembly into a receptacle;
t. suspending the aeration assembly above the receptacle by applying a force to the juncture, which is sufficient to overcome gravity, such that the predetermined length of a lift line affixed to one of the at least two ends is unequal to the predetermined length of a line affixed to another of the at least two ends as the juncture is positioned above a plane of the supporting grid;
u. lowering the suspended aeration assembly, while continuing to apply the force to the juncture, into the receptacle;
v. the aeration assembly being lowered until one of the at least two ends of the supporting grid breaks a top surface of wastewater contained in the receptacle; and
w. the aeration assembly being lowered to a position on the floor of the receptacle.

Although the disclosed aeration assemblies and methods of moving them into or out of the receptacles have been described in relation to the biological treatment of wastewater in municipal and industrial settings, it is understood that other biological treatment processes may benefit from the invention including, but not limited to, activated sludge processing, extended aeration processing, sequencing batch reactors, and membrane bioreactors.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

What is claimed is:

1. An aeration assembly for submersion in and aeration of wastewater contained in a receptacle comprising a non-floating planar grid supporting a plurality of gas diffuser panels, said supporting grid having at least two ends and including:
(a) one or more gas inlets affixed to one of the at least two ends for supplying gas to said plurality of gas diffuser panels; and
(b) one or more lift lines of a predetermined length affixed to each of the at least two ends with all lift lines meeting at a juncture, said juncture being positioned above a plane of said supporting grid so that the predetermined length of a line affixed to one of the at least two ends is unequal to the predetermined length of a line affixed to another of the at least two ends.

2. The aeration assembly of claim 1 which further comprises one or more placement guides.

3. The aeration assembly of claim 1 whose supporting grid is rectangular.

4. The aeration assembly of claim 3 in which two lift lines are affixed to each of the at least two ends, such that a lift line is affixed at or near each corner of the rectangular supporting grid.

5. The aeration assembly of claim 4 in which two lift lines each affixed to an adjacent corner are of substantially the same predetermined lengths.

6. The aeration assembly of claim 1 in which the one or more gas inlets comprises a first gas inlet in fluid communication with a first portion of the plurality of gas diffuser panels; and a second gas inlet in fluid communication with a second portion of the plurality of gas diffuser panels; and wherein a first valve is configured to control the flow of gas through the first portion and a second valve is configured to control the flow of gas through the second portion.

7. Two or more aeration assemblies of claim 1 positioned on a floor of the receptacle, each aeration assembly capable of being lifted from the floor of the receptacle while another remains on the floor of the receptacle.

8. Two or more aeration assemblies of claim 1 positioned on a floor of the receptacle, each aeration assembly capable of being lifted from the floor of the receptacle while another remains in operation on the floor of the receptacle.

9. Two or more aeration assemblies of claim 1 positioned on a floor of the receptacle, each aeration assembly capable of being operated such that gas is permitted to flow through at least one aeration assembly while gas flow through another aeration assembly is shut off.

10. A method of lifting an aeration assembly positioned on a floor of a receptacle, the aeration assembly comprising a non-floating planar grid supporting a plurality of gas diffuser panels, said supporting grid having at least two ends, each end affixed to one or more lift lines of a predetermined length with all lift lines meeting at a juncture, the method comprising:
(a) providing a connection to the juncture such that the predetermined length of a lift line affixed to one of the at least two ends is unequal to the predetermined length of a line affixed to another of the at least two ends when the juncture is positioned above a plane of said supporting grid; and
(b) applying a force to the juncture, using the connection, sufficient to lift the aeration assembly from its position on the floor of the receptacle.

11. The method of claim 10 in which the force is applied until one of the at least two ends of the supporting grid emerges from a top surface of wastewater contained in the receptacle.

12. The method of claim 10 in which the force is applied until the aeration assembly is lifted above the receptacle.

13. A method of lowering an aeration assembly into a receptacle, the aeration assembly comprising a non-floating planar grid supporting a plurality of gas diffuser panels, said supporting grid having at least two ends, each end affixed to one or more lift lines of a predetermined length with all lift lines meeting at a juncture, the method comprising:
(a) suspending the aeration assembly above the receptacle by applying a force to the juncture, which is sufficient to overcome gravity, such that the predetermined length of a lift line affixed to one of the at least two ends is unequal to the predetermined length of a line affixed to another of the at least two ends as the juncture is positioned above a plane of said supporting grid; and
(b) lowering the suspended aeration assembly, while continuing to apply the force to the juncture, into the receptacle.

14. The method of claim 13 in which the aeration assembly is lowered until one of the at least two ends of the supporting grid breaks a top surface of wastewater contained in the receptacle.

15. The method of claim 13 in which the aeration assembly is lowered to a position on the floor of the receptacle.
